(19) United States
(12) Patent Application Publication
(10) Pub. No.: US 2017/0095688 A1
(43) Pub. Date: Apr. 6, 2017

(54) Clamping Device

(71) Applicant: Tyler Scott Stilson, Frederick, CO (US)

(72) Inventor: Tyler Scott Stilson, Frederick, CO (US)

(21) Appl. No.: 15/206,220

(22) Filed: Jul. 8, 2016

Related U.S. Application Data
(63) Continuation-in-part of application No. 14/943,024, filed on Nov. 23, 2015, now abandoned.
(60) Provisional application No. 62/080,168, filed on Nov. 14, 2014.

(51) Int. Cl. A63B 21/072; F16B 2/18

(52) U.S. Cl. CPC A63B 21/0728; F16B 2/185

(57) ABSTRACT

A clamping device for securely engaging one or more objects through the application of force. The clamping device includes a primary member having opposed interior and exterior surfaces. The primary member has a generally cylindrical shape such that the interior surface defines a generally circular space about the center axis of the primary member. The clamping device can receive an elongated member through the generally circular space circumscribed by the primary member. The primary member is adapted for clamping and releasing. The clamping device further incorporates a means for releasably engaging the elongated member. The means for releasably engaging the elongated member is attached to the primary member such that when the means for releasably engaging the elongated member is in the closed position, the elongated member is securely retained by the clamping device through the application of pressure.

### CROSS-REFERENCE TO RELATED APPLICATIONS

This application is a continuation-in-part of U.S. Nonprovisional patent application Ser. No. 14/943,024, filed Nov. 16, 2015, which claimed the benefit of U.S. Provisional Patent Application Ser. No. 621080,168, filed Nov. 14, 2014.

### BACKGROUND OF THE INVENTION

1. Field of the Invention

The present invention relates generally to clamping devices. More particularly, the present invention relates to a devise used to secure weights on exercise equipment.

2. Description of the Related Art

A clamping device is an apparatus that engages one or more objects for the purpose of securely retaining the object or objects. Design considerations for clamping devices include overall size, weight, number of component parts, means for joining component parts, quality of feedstock, likelihood of improper use, ability to prevent movement and separation when engaging multiple objects, propensity to become deformed or break through use, and means for engaging and releasing the device.

These design considerations will affect whether a clamping device is able to function reliable and in what circumstances. It is possible for more than one of the identified considerations to impact a single design feature. Typically, clamping devices take a limited number of the above design factors into consideration.

Thus, a clamping device capable of reliably engaging one or more objects securely may be too large or heavy for the intended use. Alternatively, such a clamping device may sacrifice ease of use for reliability. Providing for the use of additional tools can increase the ability of a clamping device to securely engage an object, while making the device more difficult to use. Ease of use can also influence whether a clamping device is regularly used or adopted by potential users.

Another potential tradeoff in the design and development of clamping devices is the quality of materials for reduced production costs. Reduction in the quality of feedstock ordinarily reduces production costs. Clamping devices constructed, even in part, from inexpensive or substandard materials can rapidly degrade through use and the passage of time.

A clamping device that is capable of engaging objects without damaging the engaged object is also desirable. A clamping device which allows a user to determine the distance between the portions of the clamping device that contact the target object with the portions of the target objection in contact with the clamping device can be over tightened by the user, increasing the possibility of damage to the target object. Also, if a contact surface of a clamping device is made of coarse materials it is more likely to damage a retained object. The likelihood that damage will occur with such a device is increased if it is used during high impact activities.

Clamping devices are commonly used during weight training to reduce conditions that restrict execution of an exercise or the ability to perform an exercise in a safe manner. Undesirable conditions include instability, imbalance, oscillation of movable parts, and separation of removable components from assemblies, equipment or apparatuses. These conditions pose a safety risk due to potential injuries and property damage.

To limit these undesirable conditions, a clamping device is favored which is able to remain securely engaged throughout the entire movement required to perform an exercise. It is also desirable for the clamping device to remain securely engaged throughout all successive repetitions of the exercise.

A common training assembly used during weight training is a barbell with removable weights loaded on in it. A clamping device can be employed to prohibit separation of the removable weights of that assembly. Additionally, a clamping device that can securely engage the barbell is desirable to prevent movement of the weights while on the barbell.

Moreover, removable weights often incorporate a sleeve positioned around their inside surface that contacts the exterior surface of the barbell. Clamping devices used to retain the weights on the barbell can damage the sleeve if the surface area that contacts the weight is insignificant due to the thickness of the clamping device.

Clamping devices which attempt to resolve more than one of the identified problems are often difficult to manufacture. More difficult still, is manufacturing an economic clamping devices that resolves more than one of the identified problems. Thus, an economic clamping device that solves more than one of the aforementioned problems is desired.

### SUMMARY OF THE INVENTION

A clamping device is disclosed for securely engaging one or more objects through the application of pressure. The clamping device includes a primary member having opposed interior and exterior surfaces. The primary member has a generally cylindrical shape such that the interior surface defines a generally circular space about the center point of the primary member. The clamping device can receive an elongated member through the generally circular space circumscribed by the primary member.

The clamping device is adapted for clamping and releasing and incorporates a means for releasably engaging the elongated member. The means for releasably engaging the elongated member has opposed open and closed positions. The means for releasably engaging the elongated member is attached to the primary member such that when the means for releasably engaging the elongated member is in the closed position, the elongated member is securely engaged by the clamping devices through the application of pressure.

### BRIEF DESCRIPTION OF THE DRAWINGS

FIG. 1 is an end view of an exemplary embodiment of the invention in the opened position;

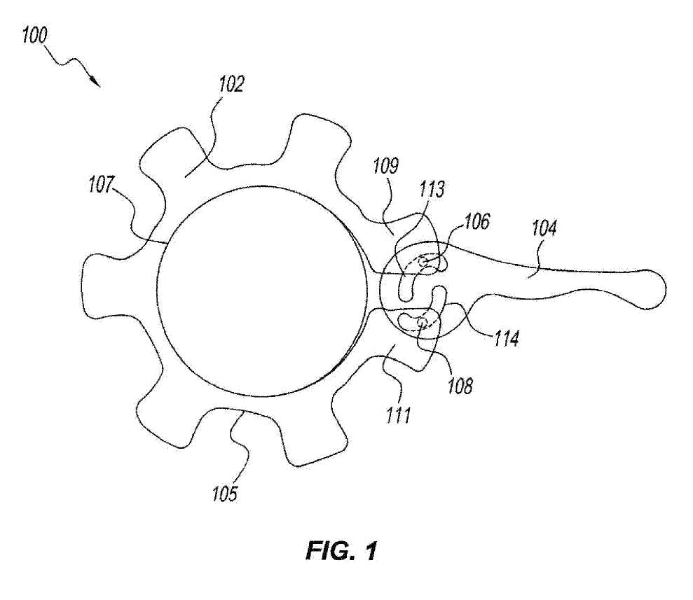

FIG. 2 is perspective view of an exemplary embodiment of the invention in the opened position;

FIG. 3 is a perspective view of an exemplary embodiment of the invention in the closed position;

FIG. 4 is a perspective view of another exemplary embodiment of the invention in the open position;

FIG. 5 is a perspective view of an exemplary embodiment of the invention in the closed position;

FIG. 6 is a perspective view of another exemplary embodiment of the invention in the opened position;

FIG. 7 is an end view of another exemplary embodiment of the invention;

Similar reference characters denote corresponding features consistently throughout the attached drawings.

### DETAILED DESCRIPTION OF THE PREFERRED EMBODIMENTS

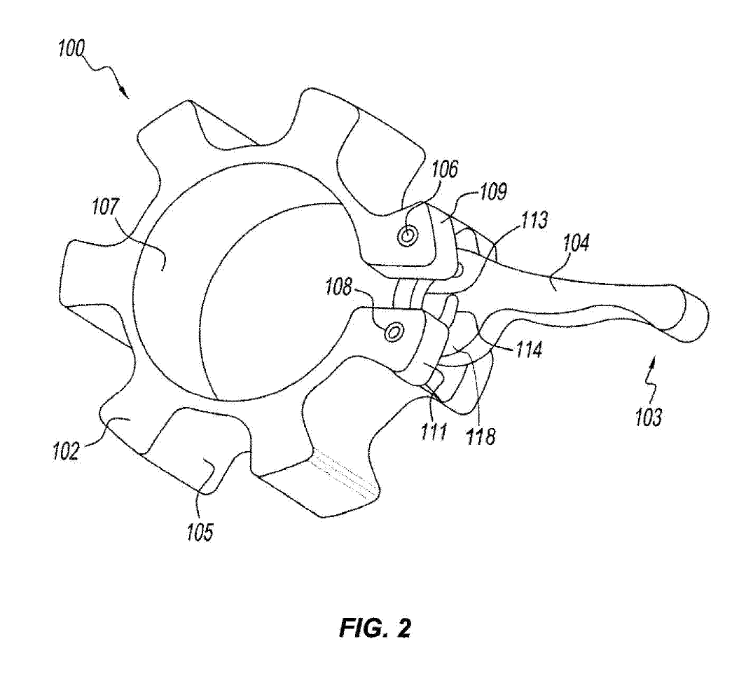

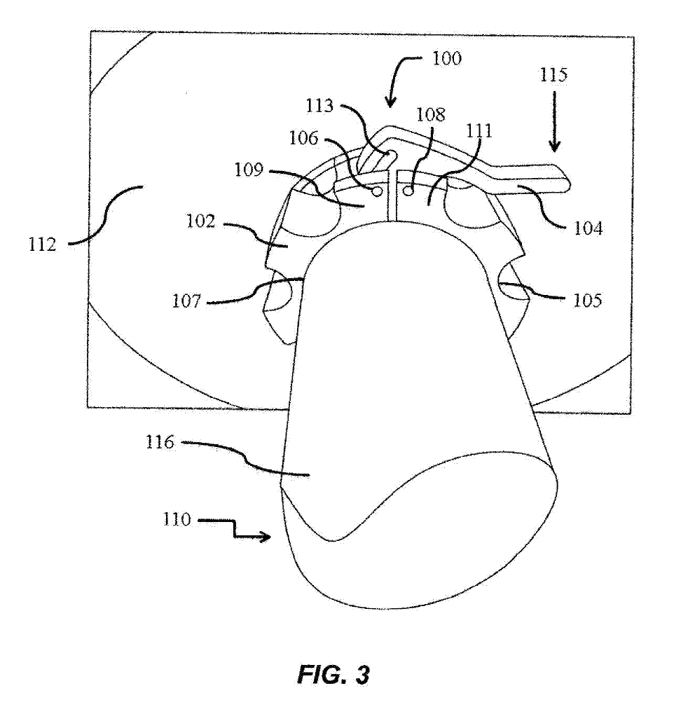

In various exemplary embodiments, the present invention relates to a clamping device 100. As shown in the exemplary embodiment in FIG. 3, the clamping device 100 securely retains one or more objects through the application of force. A perspective view of one embodiment of the clamping device is shown in FIG. 2. As illustrated in FIG. 2, the clamping device 100 is shown with a primary member 102 that is generally cylindrical with a height along the center axis of the primary member 102. The primary member 102 is preferably one continual piece. The primary member 102 having an interior surface 107 and an opposed exterior surface 105. The interior and exterior surfaces 107, 105 follow a generally circular path about the center axis of the primary member 102. The primary member 102 can also be formed from a plurality of component parts rotatably joined by any suitable means for connecting, such as a hinge or connecting pin, or a combination thereof.

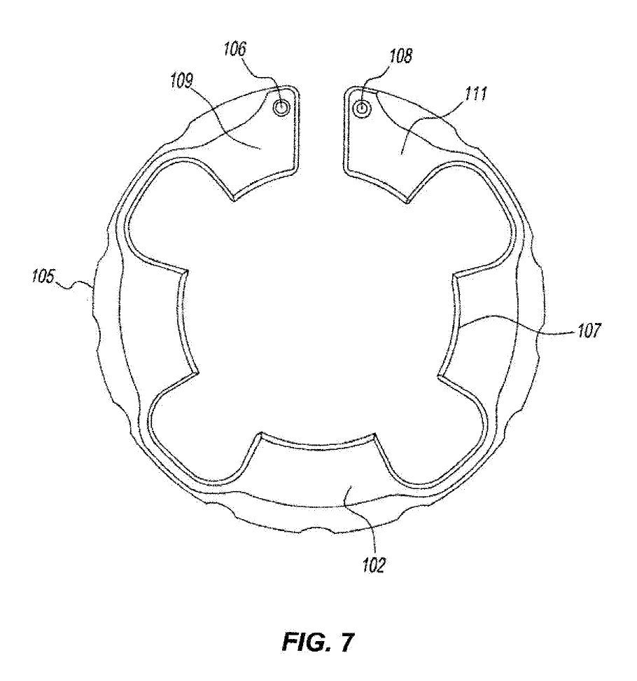

In the particular embodiment shown in FIG. 2, the exterior surface 105 follows a repeating generally parabolic path when the clamping device 100 is observed from an end view. The pattern displayed by the exterior surface 105 in the embodiment of FIG. 2 is shown for exemplary purposes only. It should be understood that the pattern and shape of said interior and exterior surfaces 107, 105 may be varied without departing from the spirit or scope of the present invention. Other potential patterns include those that are substantially triangular or crescent when viewing the clamping device 100 from an end view. FIG. 7 shows the exterior surface 105 remaining generally circular around the circumference of the primary member 102. The opposed interior surface 107 moving closer and further away from the exterior surface 105 as the interior and exterior surfaces 107, 105 move in a generally circular direction about the center axis of the primary member 102.

FIG. 2 further shows the primary member 102 with two extremities 109, 111. The primary member being sufficiently rigid to bias the first extremity 109 away from the second extremity 111. The two extremities 109, 111 being sufficiently distant from each other 109, 111 to allow one or more objects (not shown) to pass through the primary member 102 along the center axis of the primary member 102. An elongated member (not shown) being one such potential object. The clamping device 100 having a means for releasably engaging 104 such elongated member. In this particular embodiment, each of the two extremities 109, 111 is suitably joined to the means for releasably engaging the elongated member 104. Further, in this embodiment, the means for releasably engaging the elongated member 104 is a lever. The lever is a preferred means for releasably engaging the elongated member 104, but not required.

FIG. 2 further shows the lever 104 in an open position 103. The lever 104 will cause the clamping device 100 to engage the elongated member by transitioning from the open position 103 to a closed position 115. In this embodiment, the clamping device 100 comprises two generally cylindrical connecting pins 106, 108 oriented such that the center axis of each is parallel to the interior surface 107 and the exterior surface 105. In the embodiment shown in FIG. 2, the lever 104 comprises a pivot end 118. In this implementation, the pivot end 118 of the lever 104 is situated in a channel formed through each extremity 109, 111 on a plane perpendicular to the interior and exterior surfaces 107, 105. The connecting pins 106, 108 couple the pivot end 118 of the lever 104 to each extremity 109, 111 by extending through counterposed arcuate holes 113, 114 formed through the pivot end 118 of the lever 104.

FIG. 3 shows the lever 104 can pivot radially about the midpoint of the connecting pins 106, 108 approximately ninety degrees to transition from the open position 103 to the closed position 115. The elongated member 110 shown in FIG. 3 is a cylindrical barbell with an outer surface 116 about the circumference of the elongated member 110 that extends axially for the entire length of the elongated member 110. In the embodiment illustrated in FIG. 3, the lever 104 decreases the diameter of the interior surface 107 when transitioning from the open position 103 to the closed position 115. The embodiment of FIG. 3 further shows that the interior surface 107 is concave, allowing the interior surface 107 to substantially contact the cylindrical barbell 110 to securely engage the cylindrical barbell through the application of pressure towards the center axis of the primary member 102 when the lever 104 is situated in the closed position 115. FIG. 3 also shows an exercise weight plate 112 removably mounted on the elongated member 110 by passing the elongated member 110 through a generally cylindrical hole formed through the center of the exercise weight plate 112 along its center axis, allowing an inside surface (not shown) of the exercise weight plate 112 to contact the outer surface 116 of the elongated member 110.

A means for preventing damage (not shown) to the exercise weight plate 112 and elongated member 110 shown in FIG. 3, such as a sleeve (not shown) positioned around the inside surface of the exercise weight plate 112, can be used. The embodiment illustrated in FIG. 3 protects the integrity of the means for preventing damage, if present, by extending radially from the center axis of the elongated member 110 to the exterior surface 105 a distance greater than the radial distance from the center axis of the elongated member 110 to the inside surface of the exercise weight plate 112.

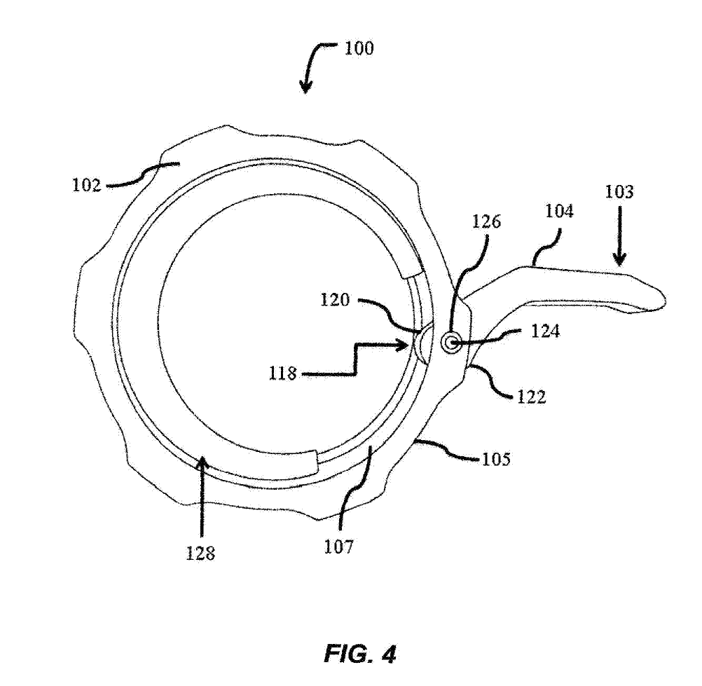

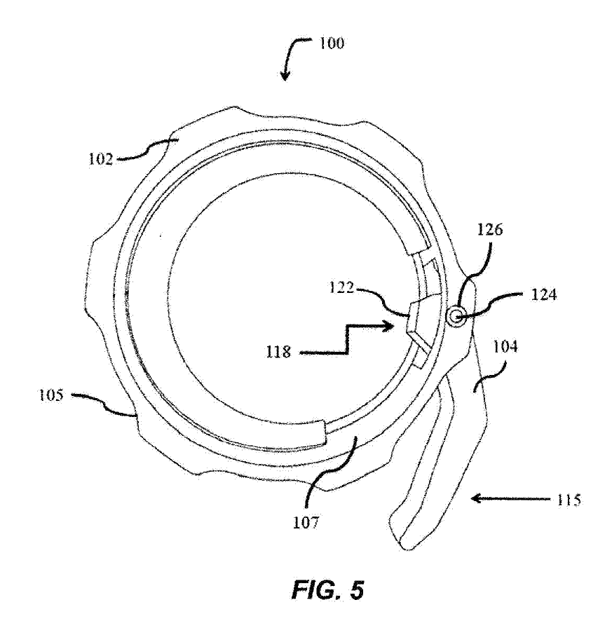

FIGS. 4 and 5 show another embodiment of the clamping device 100. In one embodiment, the primary member 102 is a cylinder having an open center along its center axis. FIG. 5 shows the means for releasably engaging the elongated member 104 comprising the pivot end 118 having an upper surface 120 and a lower surface 122 such that when said means for releasably engaging the elongated member 104 is in the closed position 116 the lower surface 122 extends towards the center axis of the primary member 102 such that the radial distance between the lower surface 122 and the center point of the primary member 102 is less than the radial distance between the interior surface 107 and the center axis of the primary member 102. The embodiment in FIG. 4 showing the means for releasably engaging the elongated member 104 in the open position 103. Further, said means for releasably engaging the elongated member 104 shown in FIG, 4 is a lever. In this embodiment, the clamping device 100 also comprises a generally cylindrical connecting pin 124 oriented such that its center axis is parallel to the center axis of the primary member 102. FIG. 4 further shows the pivot end 118 of the lever 104 situated in a hole formed through the interior and exterior surfaces 107, 106 along the height of the primary member 102. The connecting pin 124 having a height sufficient to span the hole formed through the interior and exterior surfaces 107, 105 along the height of the primary member 102. The connecting pin 124 couples the pivot end 118 to the primary member 102 by extending through a generally cylindrical hole 126 formed through the pivot end 118 of the lever 104. In a further embodiment, a non-rigid material 128 is positioned around at least a portion of the interior surface 107 of the primary member 102. The non-rigid material 128 is formed or coated with a frictionally engaging material, such as rubber, to securely engage the elongated member (not shown) when the means for releasably engaging the elongated member 104 is in the closed position 115.

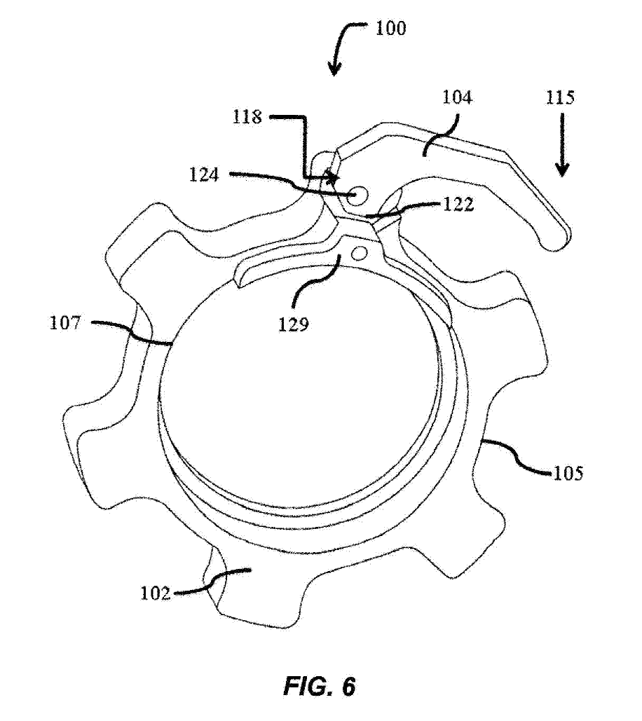

FIG. 6 shows a particular embodiment of the clamping device 100. In this particular embodiment, an engaging agent 129 is positioned between the pivot end 118 and the center axis of the primary member 102. The engaging agent 129 is suitably mounted to the primary member 102 such that when the means for releasably engaging the elongated member 104 is in the closed position 115 said engaging agent 129 is depressed so that at least one lowest point of the engaging agent 129 contacts the elongated member (not shown), allowing the clamping device 100 to securely engage said elongated member through the application of pressure towards the center axis of the primary member 102. In the alternative embodiment of FIG. 6, the engaging agent 129 is formed or coated with a frictionally engaging material, such as rubber, to securely engage the elongated member (not shown) when the means for releasably engaging the elongated member 104 is in the dosed position 115. In FIG. 8, the means for releasably engaging the elongated member 104 pivots radially about the midpoint of the connecting pin 124 greater than ninety degrees to transition from the open position 103 to the closed position 115, allowing said pivot end 118 to contact the engaging agent 129.

The clamping device 100 can be created using multiple types of feedstock, that is to say the main raw material used in the manufacture of a product. In one exemplary embodiment, the clamping device 100 is made from an aluminum alloy (not indicated). In a preferred embodiment, the aluminum alloy 6061 Billet, formerly referred to as Alloy 618. Other preferred materials for construction of the clamping device 100 include plastics (not indicated) and steel (not indicated). It is also possible to use different materials to construct different component parts of the clamping device 100.

The preferred embodiment easily, quickly and securely engages objects, such as exercise equipment. The preferred embodiment is also able to easily and quickly disengaged from the objects. When utilizing exercise equipment, the preferred embodiment allows weights to be conveniently removed or added to the exercise equipment.

It should be understood that the invention is not limited in its application to the details of the particular arrangement shown here since the invention is capable of other embodiments, some of which may be quite different from those of the disclosed embodiments. While the foregoing written description of the invention enables one of ordinary skill in the art to make and use what is presently considered by the inventor to be the best mode of the invention, a device may be practiced which incorporates other structural and/or functional details in addition to or other than the structural and/or functional details set forth herein. It should therefore be understood that the present invention is not limited to the embodiments described above, but encompasses any and all embodiments within the scope and spirit of the invention as claimed.

I claim:

1. A clamping device, comprising
a primary member having opposed interior and exterior surfaces, said primary member having a generally cylindrical shape such that the interior surface circumscribes a generally circular space around the center point of said primary member, whereby the primary member can receive an elongated member through the generally circular space, said primary member being adapted for clamping and releasing;
a means for releasably engaging the elongated member, said means for releasably engaging the elongated member having an open position and a closed position, said means for releasably engaging the elongated member is attached to said primary member such that when said means for releasably engaging the elongated member is in the closed position the elongated member is securely engaged through the application of pressure.

2. The clamping device of claim 1, wherein said means for releasably engaging the elongated member is a lever.

3. The clamping device of claim 2, wherein said lever is connected to said primary member by at least one pin whereby said lever can rotate about the pin when moving from the open position to the closed position.

4. The clamping device of claim 1, further comprising means for attaching said means for releasably engaging the elongated member to said primary member such that the means for releasably engaging the elongated member can quickly transition between the open and closed positions.

5. The clamping device of claim 1, wherein said means for releasably engaging the elongated member having an upper end and a lower end such that when said means for releasably engaging the elongated member is in the closed position the lower end thereof extends below the interior surface of said primary member to contact the elongated member.

6. The clamping device of claim 1, wherein said primary member having a first end and a second end, the first end thereof having an outer surface and the second end of said primary member having an outer surface, the first end of said primary member being oriented sufficiently close to the second end of said primary member such that when the means for releasably engaging the elongated member is in the closed position the elongated member is securely engaged by the clamping device.

7. The clamping device of claim 6, wherein said means for releasably engaging the elongated member is connected to the first end of said primary member and the second end of said primary member such that when in the closed position the distance between the outer surface of the first end and the outer surface of the second end is sufficiently reduced for the clamping device to securely engage the elongated member.

8. The clamping device of claim 1, wherein portions of the interior surface of said primary member do not contact the elongated member when the means for reasonably engaging the elongated member is in the closed position.

9. The clamping device of claim 1, wherein said elongated member is a barbell.

10. The clamping device of claim 1, wherein a lining on the interior surface of said primary member is employed to reduce contact between the interior surface of said primary member and the elongated, member.

11. The clamping device of claim 1, wherein said primary member is made, at least in part, of a material selected from, the group consisting of aluminum alloys plastics, steel and combinations thereof.

12. The clamping device of claim 1, wherein said primary member is made of an aluminum alloy that comprises between about 0.4 wt % and about 0.8 wt % of Silicon (Si), between about 0 wt % and about 0.7 wt % of Iron (Fe), between about 0.15 wt % and about 0.4 wt % of Copper (Cu), between about 0 wt % and about 0.15 wt % of Manganese (Mn), between about 0.8 wt % and about 1.2 wt % of Magnesium (Mg), between about 0.04 wt % and about 0.35 wt % of Chromium (Cr), between about 0 wt % and about 0.25 wt % of Zinc (Zn), between about 0 wt % and about 0.15 wt % of Titanium (Ti), no more than 0.15 wt % of other elements combined, no more than 0.05 wt % of any other' individual demerit, between about 95.85 wt % and about 98.56 wt % of Aluminum (Al).

13. A clamping device, comprising:
a generally cylindrical body adapted for clamping and releasing, said generally cylindrical body having opposed interior and exterior surfaces, said generally cylindrical body having a first end and a second end, the first end thereof having an outer surface and the second end of said generally cylindrical body having an outer surface, the opposed interior and exterior surfaces begin at the outer surface of the first end of said generally cylindrical body and follow a generally circular path to the outer surface of the second end of said generally cylindrical body such that the general cylindrical body can receive an elongated member through its center;
a means for releasably securing the elongated member, said means for releasably securing the elongated member having an open position and a closed position, said, means for releasably securing the elongated member is attached to said generally cylindrical body such that when said means for releasably securing the elongated member is engaged the first end of said generally cylindrical body is forced closer to the second end of said generally cylindrical body causing the elongated member to be securely engaged.

14. The clamping device of claim 13, wherein said means for releasably securing said generally cylindrical body is a lever.

15. The clamping device of claim 13, wherein a lining on the interior surface of said generally cylindrical body is employed to reduce contact between the interior surface of said generally cylindrical body and the elongated member.

16. The clamping device of claim 14, wherein said lever is connected to said generally cylindrical body by at least one pin in each of the first end and second end of said generally cylindrical body whereby said lever can rotate about the pin in each of the first and second ends when moving from the active position to the relaxed position.

17. The clamping device of claim 13, wherein portions of the interior surface of said generally cylindrical body are recessed such that the amount of surface area of the interior surface that is capable of contacting the elongated member is reduced when the means for releasably securing the elongated member is in the active position.

18. The clamping device of claim 13, wherein said elongated member is a barbell.

19. The clamping device of claim 13, wherein said clamping device is made, at least in part, of a material, selected from the group consisting of: aluminum alloys, plastics, steel and combinations thereof.

20. The clamping device of claim 14, wherein said clamping device is made of an aluminum alloy that comprises between about 0.4 wt % and about 0.8 wt % of Silicon (Si), between about 0 wt % and about 0.7 wt % of Iron (Fe), between about 0.15 wt % and about 0.4 wt % of Copper (C) between about 0 wt % and about 0.15 wt % of Manganese (Mn), between about 0.8 wt % and about 1.2 wt % of Magnesium (Mg), between about 0.04 wt % and about 0.35 wt % of Chromium (Cr), between about 0 wt % and about 0.25 wt % of Zinc (Zn), between about 0 wt % and about 0,15 wt % of Titanium (Ti), no more than 0.15 wt % of other elements combined, no more than 0.05 wt % of any other individual element, between about 95.85 wt % and about 98.56 wt % of Aluminum (Al).
